(19) United States
(12) Patent Application Publication
(10) Pub. No.: US 2020/0380406 A1
(43) Pub. Date: Dec. 3, 2020

(54) DYNAMIC USER FEEDBACK FOR EFFICIENT MACHINE LEARNING

(71) Applicant: INTERNATIONAL BUSINESS MACHINES CORPORATION, ARMONK, NY (US)

(72) Inventors: Rachael Marie Huston Dickens, Raleigh, NC (US); Jonathan F. Brunn, Logan, UT (US); RUI ZHANG, San Francisco, CA (US)

(21) Appl. No.: 16/429,169

(22) Filed: Jun. 3, 2019

(51) Int. Cl. G06N 20/00

(52) U.S. Cl. CPC G06N 20/00

(57) ABSTRACT

A method, computer system, and a computer program product for efficient machine learning is provided. Embodiments of the present invention may include training a machine learning model offline. Embodiments of the present invention may include receiving and storing user feedback to the machine learning model for a current interval. Embodiments of the present invention may include determining that a machine learning model performance is redundant. Embodiments of the present invention may include converting the machine learning model performance to an increase in a performance speed. Embodiments of the present invention may include updating the trained machine learning model online.

### BACKGROUND

The present invention relates generally to the field of computing, and more particularly to machine learning. Training a machine learning model and progressively improving the model performance may be accomplished by a process called labeling. Labeling may be performed offline by experts or skilled users who may have strong knowledge of the domain and dataset. Typically, few people have access to labeling the data and providing ground truth to a machine learning model.

### SUMMARY

Embodiments of the present invention disclose a method, computer system, and a computer program product for efficient machine learning. Embodiments of the present invention may include training a machine learning model offline. Embodiments of the present invention may include receiving and storing user feedback to the machine learning model for a current interval. Embodiments of the present invention may include determining that a machine learning model performance is redundant. Embodiments of the present invention may include converting the machine learning model performance to an increase in a performance speed. Embodiments of the present invention may include updating the trained machine learning model online.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an example graphical representation of the learning curves according to at least one embodiment;

FIG. 3 is an operational flowchart illustrating a process for a dynamic user feedback collection for efficient machine learning according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

As previously described, training a machine learning (ML) model and progressively improving the model performance may be accomplished by a process called labeling. Labeling may be performed offline by experts or skilled users who have strong knowledge of the domain and dataset. Typically, few people have access to labeling the data and providing ground truth to a ML model. Thus, labeling may be used to incrementally update or further train a model for high accuracy at a slower pace. Therefore, it may be advantageous to, among other things, leverage the labeling of the training data used for ML by incorporating feedback from multiple users as ground truth.

The following described exemplary embodiments provide a system, method and program product for ML based on user feedback. As such, embodiments of the present invention have the capacity to improve the technical field of ML by building a dynamic feedback ML system, method and program product. More specifically, a dynamic feedback program may alter the speed in which the ML model trains and learns. The faster a ML model may learn, the less precision in the predictive ML model results may be provided to a user. A balance and a threshold may be determined for users that may prefer a faster model that may be slightly less accurate, rather than a slower and highly accurate model. A threshold may be set to provide a user with fast but less accurate results, however, the less accurate results may still be in a reasonable range to the user. Alternatively, if the results become unreasonable to the user, then the dynamic feedback program may slow down the ML model training to raise the accuracy of the results to a reasonable level for the user.

Various types of ML models may be built to create predictive results for various domains, such as retail, social media content, business, technology, medical, academic, government, industrial, food chain, legal or automotive. ML models may also include deep learning models and artificial intelligence (AI). Training and updating a ML model may include supervised, unsupervised and semi-supervised ML procedures. Supervised learning may use a labeled dataset or a labeled training set to build, train and update a model. Unsupervised learning may use all unlabeled data to train a deep learning model. Semi-supervised learning may use both labeled datasets and unlabeled datasets to train a deep learning model.

Supervised learning and semi-supervised learning may incorporate ground truth by having an individual check the accuracy of the data, data labels and data classifications. Individuals are typically a subject matter expert (SME) who have extensive knowledge in the particular domain of the dataset. The SME input may represent ground truth for the ML model and the provided ground truth may raise the accuracy of the model. The SME may correct, amend, update or remove the classification of the data or data labels by manually updating the labeled dataset. ML models improve in accuracy as datasets are corrected by a SME, however, manually annotating large amounts of data may be time-intensive and complex.

According to an embodiment, supervised or semi-supervised ML may be used to allow an individual (e.g., a user, a SME, an expert or an administrator) to have some control over the ML model by having the ability to validate, alter, update or change the training set. Users may provide input or feedback into a ML model by altering the training set as opposed to an unsupervised ML environment, when a user may not provide input to the data. The training set of data may include parameters of a classifier or a label for learning purposes and a supervised or semi-supervised ML environment may allow user to update the training set based on user experience.

Various cognitive analyses may be used, such as natural language processing (NLP), semantic analysis and sentiment analysis during the building and training of a ML model. The cognitive analytics may analyze both structured and unstructured data to be incorporated into the ML process. NLP may be used to analyze the quality of data, feedback or a conversation based on the received data. Structured data may include data that is highly organized, such as a spreadsheet, relational database or data that is stored in a fixed field. Unstructured data may include data that is not organized and has an unconventional internal structure, such as a portable document format (PDF), an image, a presentation, a webpage, video content, audio content, an email, a word processing document or multimedia content. The received data may be processed through NLP to extract information that is meaningful to a user.

Semantic analysis may be used to infer the complexity, meaning and intent of interactions based on the collected and stored data, both verbal and non-verbal. For example, verbal data may include data collected by a microphone that collects the user dialog for voice analysis to infer the emotion level of the user. Non-verbal data may include, for example, text-based data or type written words, such as a social media post, a retail purchase product review, a movie review, a text message, an instant message or an email message. Semantic analysis may also consider syntactic structures at various levels to infer meaning to words, phrases, sentences and paragraphs used by the user.

Historical data and current data may be used for analysis and added to a corpus or a database that stores the training data, the real-time data, the predictive results, the user feedback and the model performance. Current data may, for example, be received from an internet of things (IoT) device, a global positioning system (GPS), a sensor, a smart watch, a smart phone, a smart tablet, a personal computer or an automotive device. Current data may generally refer to, for example, data relating to a user's preference and a collection method to obtain the user's preferences, such as via type-written messages, video content, audio content or biometric content. Historical data may include, for example, training data, user preferences, user historical feedback, previous model performance, model performance levels for each user and model learning curves.

Sentiment analysis may be used to understand how communication may be received by a user or interpreted by the user. Sentiment analysis may be processed through, for example, voice identifier software received by a microphone, facial expression identifier software received by a camera or biometric identifier software received by a wearable device such as a smart watch. Sentiment may also be measured by the tone of voice of the individuals communicating and the syntactic tone in type-written messages, such as a social media post, a text message or an email message.

According to an embodiment, for real-time data being collected and accessed, such as user profile data, user preference data, user biometric data or user feedback data being transmitted to and received by computing devices, a dynamic feedback program may receive consent from the user, via an opt-in feature or an opt-out feature, prior to commencing the collecting of data or the monitoring and analyzing of the collected data. For example, in some embodiments, the dynamic feedback program may notify the user when the collection of data begins via a graphical user interface (GUI) or a screen on a computing device. The user may be provided with a prompt or a notification to acknowledge an opt-in feature or an opt-out feature.

According to an embodiment, the confidence level or a tolerance level of a user may be measured to determine how accurately a model may produce reasonable predictive results for the user. A confidence level may be measured based on the user's feedback and a mitigation of the user's responses may be monitored to sense or identify a user's positive sentiment, negative sentiment, frustrated sentiment or distrust of a model. The ML model may be trained by user feedback to provide personalized model predictions. The user feedback may be used as ground truth to label the predictive results. The model may be incrementally updated by a user to result in progressively superior versions of the model.

The user feedback may be considered a labeling procedure of the data or ground truth. User feedback may represent an accurate reflection of the personal preferences of the users or of the individuals that may benefit from the predictions. User feedback may include, for example, a response to the predictive results, such as giving a rating of a number of stars out of five stars for a retail purchase or by responding to the retail purchase with commentary available for public review. User personal preferences may include, for example, settings created by the user on a social media site, such as muting an individual, turning on a notification setting or turning off a notification setting for another individual.

Typically, with SME ground truth, the labeling of data may be done in an offline environment, however, the present embodiment may collect user feedback as ground truth in an online environment. The online user feedback may be leveraged for one more users that are consuming the predictions determined by the model. For example, product sentiment analysis may predict the sentiment of consumer comments about the product as positive sentiment or negative sentiment. The comments predicted as negative sentiment may be shown to the user of the product and the user of the product may be given the opportunity to provide feedback regarding the actual polarity of the comments.

Collecting, storing and analyzing the user feedback may assist in dynamically determining when a user may be more tolerant of lower quality predictions. A user analysis may be made, for example, based on user preferences, current circumstances and user experience data collection. In an enterprise messaging environment, the user preferences may include, for example, a user's global notification settings, how often a user updates notification settings, the number of topics followed, the number of topics engaged in, the number of discussion channels with per-channel notification settings that differ from the global default, the average number of unread channels, the number of channels, people or contacts marked as important or the number of channels, people or contacts muted.

Current circumstances may include, for example, whether or not a user is actively typing, in a meeting, viewing a particular day of the week, engaged in a high-priority task or an important space, on a mobile device or on a desktop computer. Data collected based on user experiences may include user positive or negative feedback. Feedback from a user may include a response, a like, an emoji, an answer to a survey or the level of engagement by providing feedback. Positive feedback may express a level of trust in the predictive model even when a user is presented with less reliable predictions. The fact that a user provides any feedback may show that the user is still has some level of engagement with the model and has not lost trust in using the model. Negative feedback may be reflected by explicit negative answers to a survey or by no engagement with the model.

Some users may accept lesser quality or less stable model predictions, therefore, allowing the model to learn faster. A user specific threshold may be calculated for a specified time period. The time period may vary, for example, a calculation may be made every 5 seconds, or a calculation may be made every 5 minutes. The model performance may be analyzed for a user and compared against the calculated user specific threshold. At the end of the time period, redundant performance may be sacrificed for faster learning by serving more predictions that may be less precise for the next time period. Serving extra predictions or additional predictions to a user may be called boost predictions. Typically, ML models serve or provide positive predictions to users, however, the dynamic feedback program may, in addition to positive predictions, provide negative predictions.

The dynamic feedback program may dynamically determine when to provide boost predictions to a user in order to mitigate user frustration or user distrust in a less accurate model during the model learning phase. Boost predictions my include negative predictions that would be provided to the model to serve to the users. The provided boost predictions may also boost or improve the model learning speed. Determinations may be made by determining the right amount of boost predictions that a user may tolerate and the preferred timing of sub-optimal results.

According to an embodiment, a measurement may be assumed by which the user gauges the performance of the predictions made by the model. A binary classification may be measured by accuracy (A), precision (P), recall (R) and/or F1, which is a compound metric of precision (P) and recall (R). Precision (P) may include a data query relationship between relevant data and retrieved data such that the number of correct relevant data results may be divided by the total number of retrieved data results. Recall (R) may include a data retrieval relationship between the total retrieved data and the successfully retrieved data such that the recall is the number of correct data results divided by the number of results that should have been provided. The compound metric (F1), also known as the F-score, the F-measure and the Fl score, measures accuracy using precision (P) and recall (R) such that the value of 1 is the optimal value of the harmonic average between the precision (P) and the recall (R) and 0 is the least optimal value.

The performance metrics may be derived from four quantities. The first quantity is the number of true positives (TP). The second quantity is the number of false positives (FP). The third quantity is the number of true negatives (TN). The fourth quantity is the number of false negatives (FN). An example illustration may use P=TP/(TP+FP) in binary classification as a performance measure. The performance measure may be relevant in one or more applications, such as in product sentiment analysis, in recommending relevant items for a user to purchase or in identifying and highlighting actions in collaborative conversations when the user directly experiences the positives (i.e., identified actions) but not the negatives.

According to an embodiment, each user may have a minimal precision (MP) that the user may accept. The minimal precision (MP) may be determined using one or more tolerance factors. Tolerance factors may indicate how much a user may be tolerant of less precise predictions. Tolerance factors may include, for example, the current circumstance of a user such as the user is currently not in a meeting. When an observed precision (P) is higher than the minimal precision (MP), then there may be a potential for providing more predictions to the user. The dynamic feedback program may determine a minimum acceptable performance for a user and a means to convert redundant performance into faster learning by making more incorrect predictions.

According to an embodiment, the minimum acceptable model performance may be represented as MP=mp′*r, with MP representing a minimal precision the user will accept from a model performance, mp representing a standard precision threshold (e.g., 0.9) and r representing the ratio between the number of tolerance factors a user satisfies and the total number of tolerance factors. Tolerance factors may include a user's current circumstances, personal preferences, other behavioral data and other factors, such as the user's overall willingness to provide feedback. Behavioral data may include, for example, a user net promoter score or previous feedback results. A net promoter score is a metric used to measure or estimate customer loyalty, such as identifying if a customer or user tends to be more positive versus negative. If the user is overly negative, then the user may receive less low confidence scored predictions (i.e., higher accuracy predictions). One additional example of a net promoter score may include identifying the user's overall willingness to provide feedback. When a tolerance factor is a continuous variable, such as changes to the number of topics the user follows, then the factor may be converted into a binary variable by setting a threshold.

In an alternate and more complex embodiment to determining a minimal model performance, a logistic regression model may be learned with the tolerance factors as the independent variables and minimal precision (MP) as the dependent variables. Tolerance factors and minimal precision (MP) values may be collected from a set of users through a survey and the logistic regression model may be built and further trained.

According to an embodiment, the means to convert redundant performance into faster learning may occur when the precision (P) is not less than the minimal precision (MP) that a user may accept. When the precision (P) is higher than the minimal precision (MP), the user may be content with the ML model predictions. However, when the precision (P) is much greater than the minimal precision (MP), then the dynamic feedback program may adjust the ML model predictions and the learning speed. The model may have the ability to learn faster while sacrificing some precision (P) when the precision (P) is much greater than the minimal precision (MP). The model may learn faster by producing more positive predictions for the users to provide feedback on.

Positive predictions (i.e., predicted positives) may include, for example, relevant advertisements or identified actions that are provided to the user. The ML model may also learn from the user feedback about incorrect positive predictions. By forcing the ML model to serve or provide negative predictions to the user, the model may learn from incorrect negative predictions (i.e., false negatives). An advertisement that is predicted as not relevant may be forced to be provided to the user, however, the user may actually label the predicated advertisement as relevant to the user. Assuming a reasonably good initial ML model from offline learning, the model may make more correct predications than incorrect predictions. Therefore, most predicted negatives that are forced or served to the user may actually be true negatives (i.e., irrelevant advertisements) and may lower the precision of a user experience.

By adjusting the predictions, the predicted negatives may be treated as predicted positives. More predictions may be offered to a user if the precision (P) value is less than the minimum precision (MP) value and conversely, less predictions (P) may be offered to a user if the precision (P) is greater than the minimal precision (MP). Additionally, if the precision (P) is greater than the minimal precision (MP), then positive predictions and negative predictions are offered to the user. If the precision (P) is less than the minimal precision (P) then only positive predictions are offered to the user.

For example, consider a time period (t) for true positives (TP), false positives (FP), true negatives (TN) and false negatives (FN) as TP[t] FP[t] TN[t] FN[t], respectively, and defining a precision (P) time period as P[t]=TP[t]/(TP[t]+FP[t]), and a false omission rate (FOR) for a time period as FOR[t]=FN[t]/(TN[t]+FN[t]). True positives (TP) may also be known as true positive predictions, false positives (FP) may be known as false positive predictions, true negatives (TN) may be known as true negative predictions and false negatives (FN) may be known as false negative predictions.

If it is assumed that based on the total number of predictions made in the next time period (t+1) to naturally scale by a factor of α that may be proportional to the number of messages that are produced in the next time period (t+1), then consider the following relationship:

TP[t+1]=αTP[t]FP[t+1]=αFP[t]TN[t+1]=αTN[t]FN[t+1]=αFN[t].

If X is the total number of negative predictions that the dynamic feedback program would randomly provide to the user as positive predictions within the next time period (t+1), then in order to move the precision P[t+1] closer to the minimal precision (MP), the following analyses may be considered:

(1−FOR[t+1])*X, where X is the true negatives that would be served as positives and since the true negatives are actually negatives by ground truth, then they may serve as positives but would become false positives, where FP[t+1] would increase by (1−FOR[t+1])*X; and

FOR[t+1]*X, where X is the false negatives that would be served as positives and since the false negatives are not actually negatives by ground truth, then they may become true positives, where TP[t+1] would increase by FOR[t+1]*X; thus

$$\begin{matrix}P [ t + 1 ] = \frac{( TP [ t + 1 ) + FOR [ t + 1 ] \times X )}{\begin{matrix}( TP [ t + 1 ] + FOR [ t + 1 ] \times X + \\ FP [ t + 1 ] + ( 1 - FOR [ t + 1 ] \times X ) )\end{matrix}} \\ = \frac{( α \times TP [ t ] + FOR [ t ] \times X )}{( α \times TP [ t ] + α \times FP [ t ] + X )}\end{matrix}$$

If we use P[t+1]=MP to move the precision in the next time period closer to the minimal precision, and by making the following assumptions and solving for X, then:

TP[t]=90 FP[t]=10 TN[t]=80 FN[t]=20 with a minimal precision (MP) of 0.8 and an α=1, then

0.8=(90+0.2X)/(100+X), solving for X, X=17.

To prevent the precision at the next time period (P[t+1]) from dropping below the minimum precision (MP) due to an inevitable inaccuracy in the estimation, an alignment may be made to make an adjustment. The alignment may be to align P[t+1] with μMP, where μ is a tunable parameter slightly greater than 1.

According to an embodiment, at the end of each time period (t), steps may be repeated based on the result from the previous time period. A first step may include observing the current precision (P) as experienced by the user by calculating using all conversations, feedback or responses obtained that relate to the user. A second step may include, if the precision as a point in time (P[t]) is smaller than or equal to the minimal precision (MP), then no adjustments may be made to the model and the dynamic feedback program may wait for the model to naturally improve in the upcoming time periods. Not making adjustments to the model will keep the model operating under normal circumstances and learning and serving predicted positives to the user. When adjustments are made to the model, the model is forced to serve both predicted positives and predicted negatives to the user in order to create a faster learning environment for the model based on user feedback on the added predicted negatives.

A third step may include, if the precision at a point in time (P[t]) is greater than the minimal precision (MP), then the dynamic feedback program may provide the user with more positive predictions until the precision (P) gets close to the minimal precision (MP). When the total predictions (TP) are low, then the ML model is making a higher number of mistakes or incorrect predictions, thus, the ML model is also learning faster from the feedback during this time. Providing more positives may be accomplished by turning the randomly selected number of negative predictions (X) that were predicted by the ML model into positives based on the calculation for X above.

Once the conditions have been met based on each time period, the dynamic feedback program may determine that the user may be tolerant of a lower precision model and the boosting predictions may be visualized to the user. The visualization may include, for example, the boosted predictions and the positive predictions provided to the user. A boosting prediction visualization may allow the user to become aware that the confidence in the prediction may not be as high as other meaningful predictions presented to the user. The dynamic feedback program may further learn from the user's response or non-response regarding the lower confidence prediction.

The predictive capabilities made may allow prediction quality tradeoffs or model accuracy tradeoffs with model learning speed based on the user satisfaction for ML models, for example, in a cloud-based online ML platform environment. The predictive capabilities may provide learning in a real-time online environment based on user feedback.

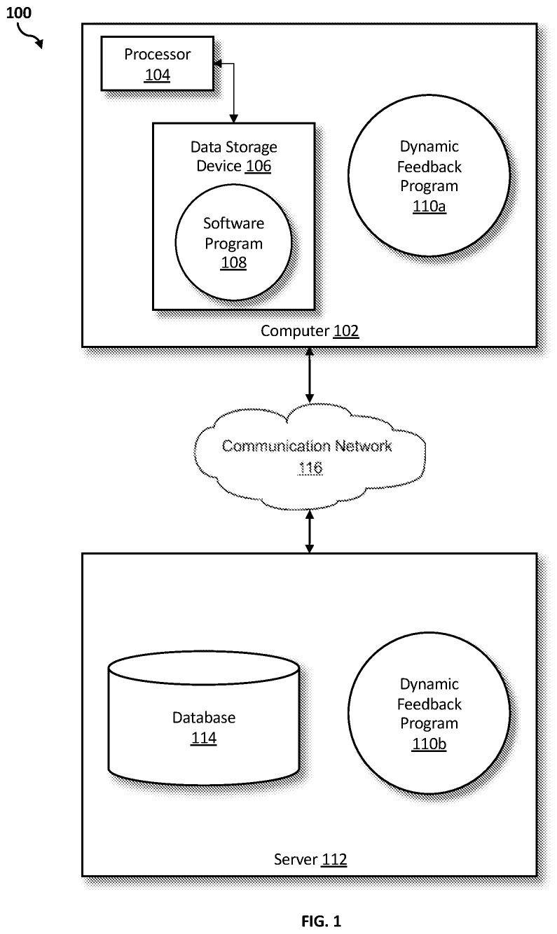

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a dynamic feedback program 110a. The networked computer environment 100 may also include a server 112 that is enabled to run a dynamic feedback program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

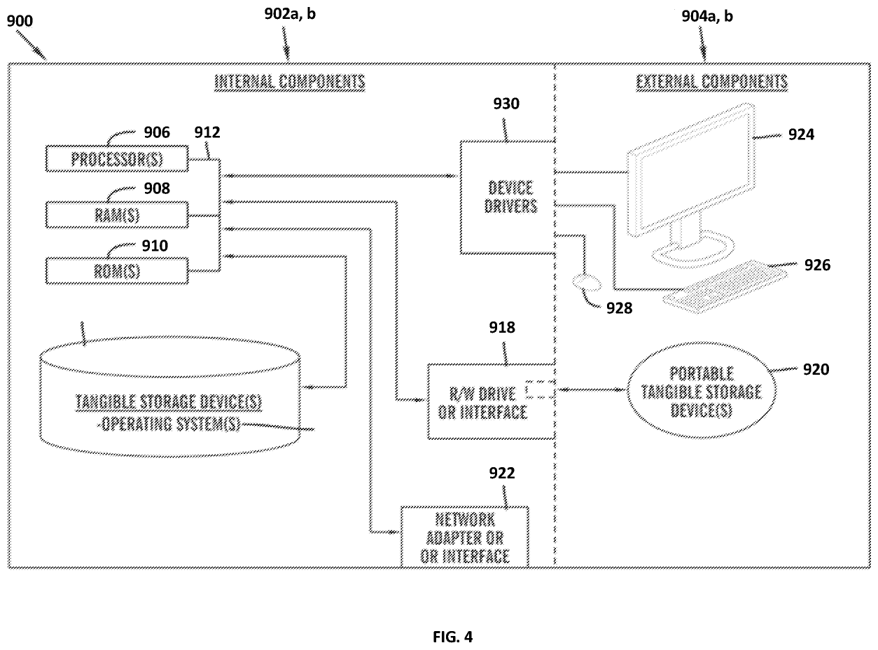

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Blockchain as a Service (BaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the dynamic feedback program 110a, 110b may interact with a database 114 that may be embedded in various storage devices, such as, but not limited to a computer/mobile device 102, a networked server 112, or a cloud storage service.

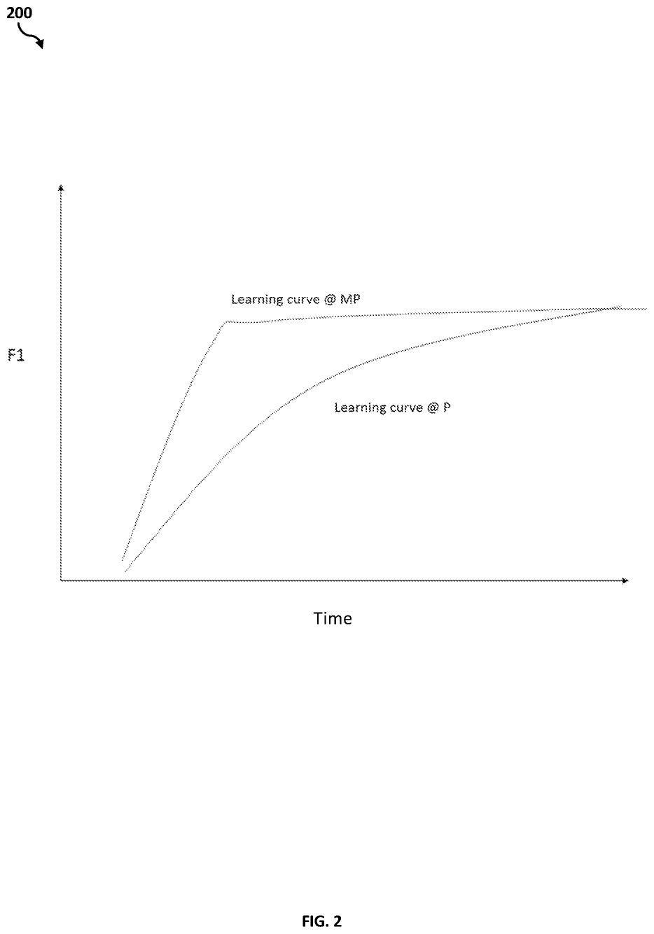

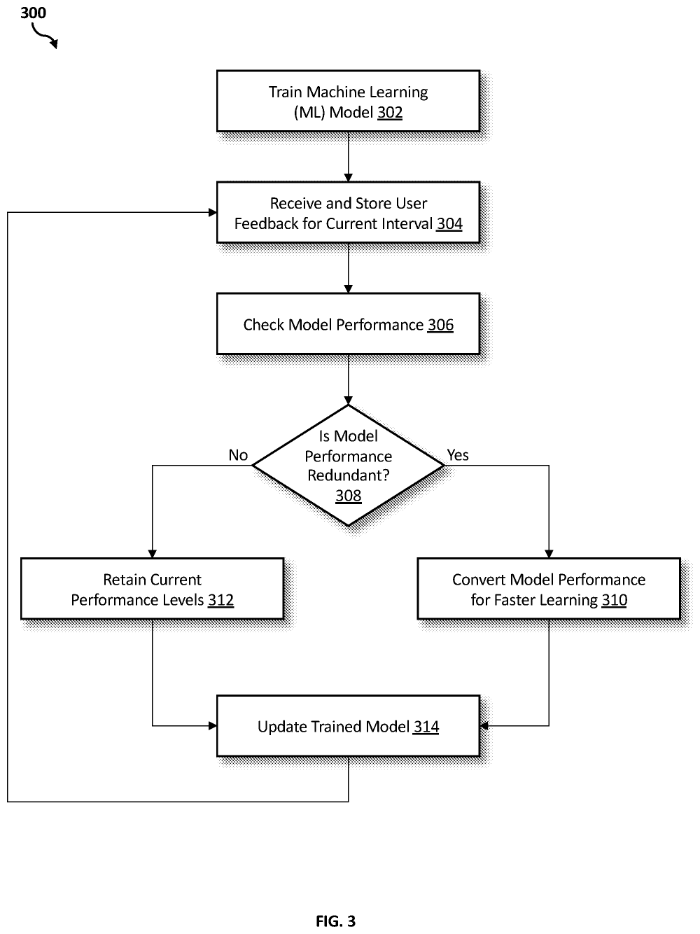

According to the present embodiment, a user using a client computer 102 or a server computer 112 may use the dynamic feedback program 110a, 110b (respectively) to mitigate model accuracy and model speed in an online ML environment. The dynamic feedback method is explained in more detail below with respect to FIGS. 2 and 3.

Referring now to FIG. 2, an example graphical representation of the learning curves 200 used by the dynamic feedback program 110a, 110b according to at least one embodiment is depicted. The example graphical representation displays the relationship between how quickly a ML model may learn based on the compound metric Fl over time. In the graphical representation, the precision (P) is greater than the minimal precision (MP), P>MP, thus, the boost predictions may be used to increase the learning speed. The learning curve at the minimal precision value (i.e., Learning curve @ MP) provides an example of the ML model quickly learning within a minimal precision value based on a compound metric of P and R, Fl, over a time period. Alternatively, the learning curve with a higher accuracy or with a higher level of precision (i.e., Learning curve @ P) shows a slower ML model learning process that more time to get close to or to level out with the learning curve at the minimal precision value.

Referring now to FIG. 3, an operational flowchart illustrating the exemplary dynamic ML model learning process 300 used by the dynamic feedback program 110a, 110b according to at least one embodiment is depicted. The dynamic feedback program 110a, 110b may dynamically adjust the level of accuracy of model predictions and the speed in which a model learns the predictions in an online computing environment based on a user's tolerance level. The dynamic feedback program 110a, 110b may also adjust the predictive quality of the model and the speed of model learning as a user adjusts in tolerance levels. The steps to an embodiment of the dynamic ML model learning process 300 are described below.

At 302, the ML model is trained. The ML model may be originally trained online or offline using supervised, semi-supervised or unsupervised ML processes. The amount of model training may vary depending on the domain being trained and the availability of historical data to begin the training.

At 304, the user feedback is received and stored for the current interval. The user feedback may be relating to the user's experiences with an application driven by the ML model, such as identifying actions or recommending items. The user feedback may be provided by the user in many forms and stored on a database, corpus or knowledgebase that pertains to the model and the domain. The user feedback may also be accessible to the dynamic feedback program 110a, 110b. User feedback may be provided in a real-time online environment, for example, in a response to a public forum or in a response to a private forum with proper accessibility privileges. The user responses may be in the form of a type-written response or recommendation, a verbal response in a public forum, a biometric response, a like, a rating level, a muting of an individual online or a preference to receive or to like notifications by a particular individual, company or club. The current interval time may be determined, for example, by the domain popularity such that domains or topics with a high amount of data and feedback available may use a shorter interval than domains with less available data and feedback. The interval size may also be built based on empirical experience. Additionally, a systematic search may be done to try varying interval sizes to determine how fast the model correspondingly improves.

At 306, the model performance is checked. Model performance may be checked based on a minimal acceptable performance for a user. The minimal acceptable performance may be represented as MP=mp′*r, with MP representing a minimal precision, mp representing a standard precision threshold example of 0.9 and r representing the ratio between the number of tolerance factors a user satisfies and the total number of tolerance factors. For example, if a value of 0.8 is used for the tolerance factor ratio, then MP=0.9*0.8 =0.72, thus, the minimal acceptable performance for the user is 0.72.

At 308, the dynamic feedback program 110a, 110b determines if the model performance is redundant. The redundant model performance may be determined based on the precision (P) value as compared to the minimal precision (MP) value. The precision (P) value is determined by P[t]=TP[t]/(TP[t]+FP[t]). The minimal precision (MP) value is determined in step 306. If the precision (P) value is a higher value than the minimal precision (MP) value, then the model performance may be considered redundant. Alternatively, if the precision (P) value is a lower value than the minimal precision (MP), then the model performance may not be considered redundant. If the variance in values between the precision (P) and minimal precision (MP) is a large variance, for example, much higher or much lower, then the large amount of redundancy for (P>>MP) may allow for reducing a larger amount of the precision (P) in order for the ML model to learn even faster. Alternatively, if the precision (P) is much lower than the minimal precision (MP), then the lack of redundancy for (P<<MP) may create more accuracy in the ML model by slowing down the learning process.

If the dynamic feedback program 110a, 110b determines that the model performance is redundant at 308, then the model performance is converted for faster learning at 310. Model performance is converted for the current time period (t) for precision (P). An analysis of multiple parameters and the relationships between the multiple parameters are performed. The multiple parameters may include adjusting the predictions by treating the negative predictions as positive predictions using relationships between true positives (TP), false positives (FP), true negatives (TN) and false negatives (FN).

The relationships created and determined for converting the model performance may include calculating the precision for the current time period P(t), the total predictions at the next time period TP(t+1), the false positives at the next time period FP(t+1), the true negatives at the next time period TN(t+1), the false negatives at the next time period FN(t+1), the precision for the next time period P(t+1) and the false omission rate for the next time period FOR(t+1).

Making the following assumptions:

TP[t]=90 FP[t]=10 TN[t]=80;

FN[t]=20;

MP=0.8; and

and α=1;

the calculations may be as follows:

$$define P [ t ] = \frac{TP [ t ]}{TP [ t ] + FP [ t ]} ; and$$

$$FOR [ t ] = \frac{FN [ t ]}{TN [ t ] + FN [ t ]} .$$

Assuming further that the total number of predictions made in the next time period to naturally scale by a factor of a and proportional to the number of messages that are produced in the next time period, then the relationships are as follows:

TP[t+1]=αTP[t]FP[t+1]=αFP[t]TN[t+1]=αTN[t]FN[t+1]=αFN[t].

If X is the total number of negative predictions that would randomly be served to the user as positive predictions within the next time period, t+1, in order to move the precision in the next time period, P[t+1] closer to the minimal precision (MP), then the relationships are as follows:

(1−FOR[t+1]×X),

with X representing the number of true negatives that would be served to a user as positives (i.e., false positives at the next time period, FP[t+1], would increase in boost predictions by (1−FOR[t+1]×X)); and

FOR[t+1]×X,

with X representing the number of false negatives that would be served to a user as positives (i.e., true positives at the next time period, TP[t+1], would increase in boost predictions by FOR[t+1]×X),

thus,

$$\begin{matrix}P [ t + 1 ] = \frac{( {TP [ t + 1 ]}_{boosted} )}{( {TP [ t + 1 ]}_{boosted} + {FP [ t + 1 ]}_{boosted} )} \\ = \frac{( TP [ t + 1 ] + FOR [ t + 1 ] \times X )}{\begin{matrix}( TP [ t + 1 ] + FOR [ t + 1 ] \times X + \\ FP [ t + 1 ] + ( 1 - FOR [ t + 1 ] \times X ) )\end{matrix}} \\ = \frac{( α \times TP [ t ] + FOR [ t ] \times X )}{( α \times TP [ t ] + α \times FP [ t ] + X )} .\end{matrix}$$

In solving for X, recall that P[t+1]=MP, therefore,

$$MP = \frac{( α \times TP [ t ] + FOR [ t ] \times X )}{( α \times TP [ t ] + α \times FP [ t ] + X )} .$$

Using the previous assumptions of with the presented relationships,

TP[t]=90 FP[t]=10 TN[t]=80;

FN[t]=20;

MP=0.8; and

and α=1;

then,

$$0.8 = \frac{( 90 + 0.2 X )}{( 100 + X )} ,$$

thus, X=17.

To prevent the precision at the next time period (P[t+1]) from dropping below the minimum precision (MP) due to an inevitable inaccuracy in the estimation, an alignment may be made to make an adjustment. The alignment may be to align P[t+1] with μMP, where μ is a tunable parameter slightly greater than 1.

If the dynamic feedback program 110a, 110b determines that the model performance is not redundant at 308, then the current performance values are retained at 312. Current performance values may indicate that the ML model may keep learning at the current and normal learning rate with user feedback. Current performance values may be retained, and no boost adjustments may be made to the model. The non-redundant performance may indicate that precision (P) value is smaller than or equal to the minimal precision (MP) value, therefore, the dynamic feedback program 110a, 110b may do nothing and wait for the model to naturally improve. The model performance will continue to improve with user feedback, however, the improvement may be at a slower rate since no boost predictions may be present to speed up the model learning.

At 314, the trained model is updated. The trained model may be updated based on the performance levels at step 310 or step 312. The updated model may be provided to users and the feedback and performance loop may be recalculated and dynamically adjusted at the end of each time period. One aspect of updating the trained model may include that once conditions have been met for the time period, then a determination may be made regarding a user tolerance level and if the user is tolerant to a lower precision, then boosting predictions may be provided based on the user tolerance. Further model learning may occur from the user's response or the user's non-response to the lower confidence predictions.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 4. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the dynamic feedback program 110a in client computer 102, and the dynamic feedback program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the dynamic feedback program 110a, 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the dynamic feedback program 110a in client computer 102 and the dynamic feedback program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the dynamic feedback program 110a in client computer 102 and the dynamic feedback program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure or on a hybrid cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

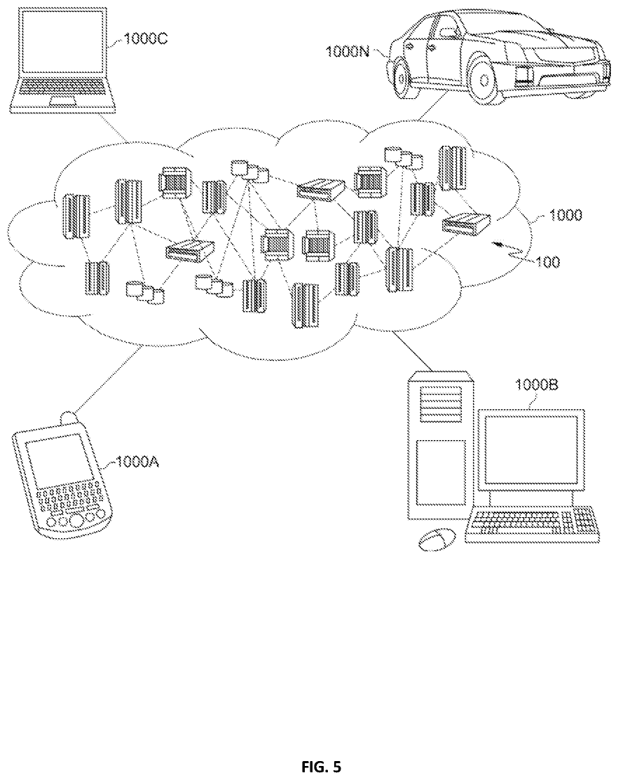

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

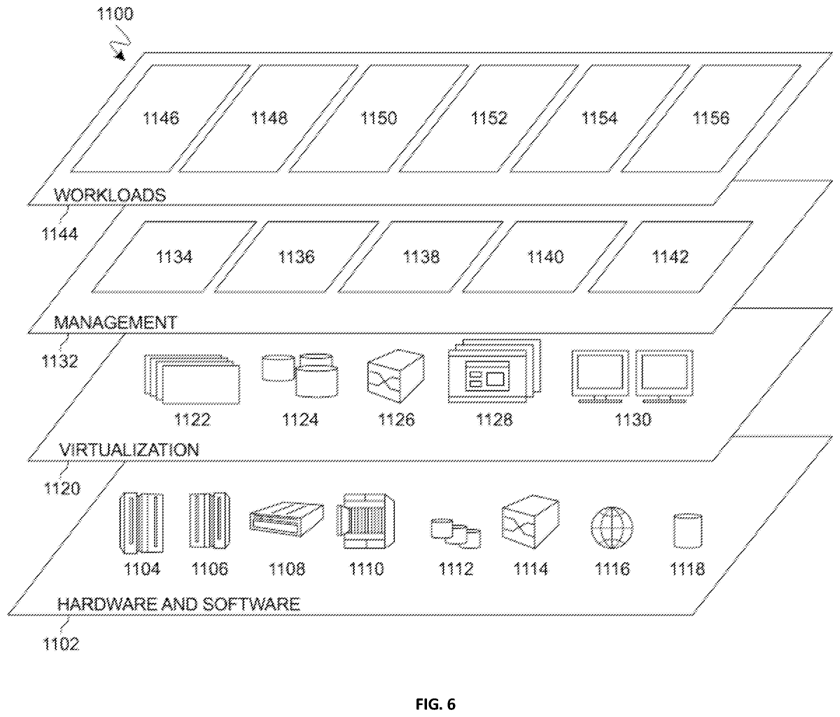

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and dynamic feedback 1156. A dynamic feedback program 110a, 110b provides a way to dynamically adjust model performance based on a user tolerance level to accurate or non-accurate predictions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for efficient machine learning, the method comprising:
training a machine learning model offline;
receiving and storing user feedback to the machine learning model for a current interval;
determining that a machine learning model performance is redundant;
converting the machine learning model performance to an increase in a performance speed; and
updating the trained machine learning model online.

2. The method of claim 1, further comprising:
evaluating the machine learning model performance;
determining the machine learning model performance is not redundant; and
retaining a current performance level.

3. The method of claim 1, wherein one or more boost predictions are provided to a user if the machine learning model is redundant.

4. The method of claim 1, wherein the machine learning model performance for a user is determined by comparing a precision value (P) with a minimal precision (MP) value.

5. The method of claim 1, wherein the redundant machine learning model performance is determined and adjusted based on a time period (t) for a precision (P), a number of true positives (TP), a number of false positives (FP), a number of true negatives (TN), a number of false negatives (FN) and a false omission rate (FOR).

6. The method of claim 1, wherein the user feedback contributes to a minimal precision of the machine learning model, wherein the minimal precision of the machine learning model is determined based on a plurality of tolerance factors.

7. The method of claim 1, wherein the updated trained machine learning model is predicted for a next time interval after the current interval, wherein the next time interval is (t+1).

8. A computer system for efficient machine learning, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
training a machine learning model offline;
receiving and storing user feedback to the machine learning model for a current interval;
determining that a machine learning model performance is redundant;
converting the machine learning model performance to an increase in a performance speed; and
updating the trained machine learning model online.

9. The computer system of claim 8, further comprising:
evaluating the machine learning model performance;
determining the machine learning model performance is not redundant; and
retaining a current performance level.

10. The computer system of claim 8, wherein one or more boost predictions are provided to a user if the machine learning model is redundant.

11. The computer system of claim 8, wherein the machine learning model performance for a user is determined by comparing a precision value (P) with a minimal precision (MP) value.

12. The computer system of claim 8, wherein the redundant machine learning model performance is determined and adjusted based on a time period (t) for a precision (P), a number of true positives (TP), a number of false positives (FP), a number of true negatives (TN), a number of false negatives (FN) and a false omission rate (FOR).

13. The computer system of claim 8, wherein the user feedback contributes to a minimal precision of the machine learning model, wherein the minimal precision of the machine learning model is determined based on a plurality of tolerance factors.

14. The computer system of claim 8, wherein the updated trained machine learning model is predicted for a next time interval after the current interval, wherein the next time interval is (t+1).

15. A computer program product for efficient machine learning, comprising:
one or more computer-readable tangible storage media and program instructions stored on at least one of the one or more computer-readable tangible storage media, the program instructions executable by a processor to cause the processor to perform a method comprising:
training a machine learning model offline;
receiving and storing user feedback to the machine learning model for a current interval;
determining that a machine learning model performance is redundant;
converting the machine learning model performance to an increase in a performance speed; and
updating the trained machine learning model online.

16. The computer program product of claim 15, further comprising:
evaluating the machine learning model performance;
determining the machine learning model performance is not redundant; and
retaining a current performance level.

17. The computer program product of claim 15, wherein one or more boost predictions are provided to a user if the machine learning model is redundant.

18. The computer program product of claim 15, wherein the machine learning model performance for a user is determined by comparing a precision value (P) with a minimal precision (MP) value.

19. The computer program product of claim 15, wherein the redundant machine learning model performance is determined and adjusted based on a time period (t) for a precision (P), a number of true positives (TP), a number of false positives (FP), a number of true negatives (TN), a number of false negatives (FN) and a false omission rate (FOR).

20. The computer program product of claim 15, wherein the user feedback contributes to a minimal precision of the machine learning model, wherein the minimal precision of the machine learning model is determined based on a plurality of tolerance factors.
